(19) United States
(12) Patent Application Publication
(10) Pub. No.: US 2014/0278585 A1
(43) Pub. Date: Sep. 18, 2014

(54) Systems and Methods for Providing Centralized Insurance Claim Processing and Plan Management

(71) Applicant: Tomorrow's Solution Inc., Deerfield Beach, FL (US)

(72) Inventor: Olivier Zerbib, Fort Lauderdale, FL (US)

(73) Assignee: Tomorrow's Solution Inc., Deerfield Beach, FL (US)

(21) Appl. No.: 14/217,035

(22) Filed: Mar. 17, 2014

Related U.S. Application Data
(60) Provisional application No. 61/801,008, filed on Mar. 15, 2013.
(60) Provisional application No. 61/953,263, filed on Mar. 14, 2014.

(51) Int. Cl. G06Q 40/08

(52) U.S. Cl. CPC G06Q 40/08
USPC 705/4

(57) ABSTRACT

A request is received from an insured member to process a claim for an incident. One or more specific insurance policies for the insured member are retrieved from a database and claim rules for each policy are retrieved from the database, producing one or more claim rules for the insured member. One or more claim questions are generated specifically for the insured member based on the one or more claim rules. One or more claim questions are sent to the insured member regarding an incident. One or more responses are received from the insured member in response to the one or more claim questions. One or more claim forms of the one or more specific insurance policies are selected based on the one or more responses and the one or more claim rules. The one or more claim forms are filled out based on the one or more responses.

### CROSS-REFERENCE TO RELATED APPLICATION

This application claims the benefit of U.S. Provisional Patent Application Ser. No. 61/801,008, filed Mar. 15, 2013; and U.S. Provisional Patent Application Ser. No. 61/953,263, filed Mar. 14, 2014.

### INTRODUCTION

Most people receive the majority of their insurance benefits through their employer. As a result, many of these people are unaware of the details of their plans, or how each plan relates to an accident or illness they may have. Also, often a person is also covered or partially covered by the insurance plan of a spouse or partner. Or, a person is also covered or partially covered by an insurance plan that was purchased outside of their employment. Consequently, when faced with the need to file a claim for an accident or illness, it is difficult for many people to first determine the correct insurance policy or policies, and second to correctly fill out the right form or forms. In short, it is difficult to manage multiple insurance plans and their claim forms across multiple insurance providers or carriers.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary screen capture of a window of a centralized insurance claim processing and plan management website that shows an insured member's specific insurance plans, in accordance with various embodiments.

FIG. 3 is an exemplary screen capture of a window of a centralized insurance claim processing and plan management website that shows how the system will automatically assist an insured member so it can determinate which claim(s) form(s) will be needed, in accordance with various embodiments.

FIG. 4 is an exemplary series of screen captures of windows of a centralized insurance claim processing and plan management website that shows a variety of questions based on the insurance plans an insured member has and also based on the responses to earlier questions are presented to an insured member, in accordance with various embodiments.

FIG. 5 is an exemplary screen capture of a window of a centralized insurance claim processing and plan management website that shows how filled out claim forms are presented to an insured member, in accordance with various embodiments.

FIG. 6 is a schematic diagram of a system for automatically filling out claim forms based on an insured member's responses to questions, in accordance with various embodiments.

FIG. 7 is a flowchart showing a method for automatically filling out claim forms based on an insured member's responses to questions, in accordance with various embodiments.

FIG. 8 is a schematic diagram of a system that includes one or more distinct software modules that performs a method for automatically filling out claim forms based on an insured member's responses to questions, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

In various embodiments, computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Systems and Methods for Providing Centralized Insurance Claim Processing and Plan Management

As described above, many people know very little about the details of their insurance policies in general and very little about the types of claims they are entitled to file for a certain injury or illness.

Embodiments of various systems and methods provide centralized insurance claim processing and plan management for one or more employees of a company or for individuals outside of a company. An employee or individual can easily access the details of all of the specific insurance plans he or she has chosen on a single page of a computer screen, regardless of the insurance carrier. Such details include, for example, brochures, deductibles, out of pocket maximums, supplemental benefits, and the maximum number of hospital stays eligible for a certain injury or illness. The system allows the employee or individual to download a claim form. Alternatively, the system automatically fills out one or more claim forms based on the information provided by the employee regarding a certain injury or illness. The system also allows the human resource (HR) personnel to easily manage employee benefits, such as automatically calculating an employee's new premium after the employee's status change, from part-time to full-time, for example.

### Employee's Access

In various embodiments, when an employee or a family member (hereinafter referred to as the “insured” or “insured member”) logs in, the insured can see all of the specific insurance plans he or she has chosen, on the same page of a computer screen. Examples of the specific plans include health insurance, dental insurance, life insurance, and long term disability insurance that offered to employees by a company. These specific plans are typically provided by different insurance carriers.

FIG. 2 is an exemplary screen capture 200 of a window of a centralized insurance claim processing and plan management website that shows an insured member's specific insurance plans, in accordance with various embodiments. Screen capture 200 shows that this insured member has a hospitalization plan 210 and a group personal accident plan 220, for example.

In various embodiments, for each of the specific insurance plan, an insured can click on a link or icon on the computer screen to view one or more brochures that describe the specific plan chosen by the insured. These brochures may be provided by different insurance carriers.

In various embodiments, an insured can view a video of a specific plan, print a claim form online, or file a claim online.

In various embodiments, an insured can be directed to a website of the specific insurance carrier (Network) by clicking on a specific link. One or more links may also be provided to direct an insured to a website maintained by an insurance carrier that provides various information, including, for example, contact information of a broker, so that the insured does not need to remember the name, phone number, or email address of the broker.

In various embodiments, the system researches all of the plans that an insured is entitled to claim based on information provided by the insured regarding an injury or illness. The system guides the insured to file a claim in each of the plans.

In various embodiments, the system automatically fills out and submits one or more claim forms for the insured based on the information provided by the insured regarding an injury or illness.

In various embodiments, the system allows an insured to monitor the claim process for each claim that he or she files, showing whether the claim is being reviewed, requesting more information, pending appeal, or being approved, for example.

In various embodiments, the insured can access the information on the specific plans, claims, and other information on any computer, such as a desktop computer, a laptop, a tablet, a portable electronic device, a smart phone, or the like.

### Claim Process

In various embodiments, when an insured files a claim, the system reviews the claim process and follows up with the insured.

In various embodiments, the system researches in all of the plans, and determines the specific plans that offer compensation for a certain injury or illness. The system ensures that the insured files a claim in each of the plans he or she is entitled to obtain compensation from.

In various embodiments, the system automatically fills out one or more claim forms for an insured, which can be printed, signed and sent in. Alternatively, the completed claim forms can be electronically signed and filed online

In various embodiments, the system monitors the claims filed by each insured and offers help with claims process.

In various embodiments, each claim filed by an insured is accessible by the insured without the need to know the claim number or other reference number provided by the insurance carrier.

### Human Resource's Access

In various embodiments, the HR personnel or the company owner can view their group insurance plan in detail and on a single page.

In various embodiments, the system calculates the total insurance benefits provided to employees and family members by the company.

In various embodiments, the HR personnel or the company owner can see all of the employees' deductions for insurance benefits on a single page and can easily update employee files with a single click.

In various embodiments, the system allows the HR personnel or company owner to easily add new employees to the group insurance plan. In various embodiments, the system sends reminders to the HR personnel a few days before a new employee becomes eligible for group insurance plan and sends an email to a broker reminding the broker to contact the HR personnel to schedule a meeting with the new employee.

In various embodiments, the system monitors the claims filed by each insured to determine if there are excessive claims filed in a certain category to detect potential abusive use of insurance claims.

In various embodiments, after the status change of an employee (from part-time to full-time, for example), the system automatically calculates the employee's new insurance premium due to his or her status change.

### Broker's Access

In various embodiments, the system allows a broker of one or more insurance carriers to easily access information on employees and/or insured members of a group insurance plan.

### Automatically Fill Out Claim Forms Based on an Insured Member's Responses to Questions

Embodiments of the system and method automatically fill out claim forms based on an insured member's responses to questions.

When an insured member wants to file an insurance claim for an incident, such as a sick visit, well visit, long-term or short-term disability, or accident, the insured member does not need to know what type of claim he or she should file or where to file. The system retrieves the insured member's personal information from a database and reminds the insured member of the coverage he or she is entitled to. The personal information includes, for example, name, date of birth, address, phone number, emergency contact, health insurance company and policy number, automobile and/or home insurance company and policy number, amount of coverage, deductible, coinsurance, out of pocket amount, exclusions, health record, accident record, type of vehicle owned, etc.

FIG. 3 is an exemplary screen capture 300 of a window of a centralized insurance claim processing and plan management website that shows how the system will automatically assist an insured member so it can determinate which claim form will be needed, in accordance with various embodiments. Screen capture 300 shows that this insured member has coverage for an accident 310 and or sickness 320. This coverage is determined from the insured member's specific insurance plans, such as those shown in FIG. 2, for example.

Next, the system presents a series of questions (e.g., in a particular order) to the insured member to obtain information related to the incident. Based on the responses provided by the insured member, the system automatically determines the type of claim that is appropriate for the incident. The responses can be, but are not limited to, simple yes or no responses, which allow the system to make accurate decisions. The system then reviews the insured member's different insurance policies to determine which policies cover that type of claim. If the insured member has one or more policies that cover that type of claim, the system uses the information gathered from the insured member (mostly from the responses provided by the insured member regarding the incident) to automatically fill out the claim form. The system also uses the insured member's personal information stored in the database to fill out the claim form. In other words, the insured member does have to determine the correct policy or claim form to be submitted. This is all determined automatically from the responses that the insured member makes to the questions presented by the system.

FIG. 4 is an exemplary series 400 of screen captures of windows of a centralized insurance claim processing and plan management website that shows a variety of questions based on the insurance plans an insured member has and also based on the responses to earlier questions are presented to an insured member, in accordance with various embodiments. In screen capture 410 the insured member is asked a yes or no question about an accident. In screen capture 420 the insured member is asked another yes or no question about the accident. As described above, the system recognizes the insured member and what they bought when the insured member logs in to the system, for example. When the insured member clicks to “file a claim” the system retrieves the insurance plans owned by the insured member. When the insured member starts to process a claim, the system asks a variety of questions based on the insurance plans an insured member has and also based on the responses to earlier questions as shown in FIG. 4. Once the system receives the responses to all of the questions, the system selects the correct claim(s) that the insured member is entitled to base on the responses provided. The claim(s) are then filed out automatically by the system.

The system may determine that the insured member is entitled to file more than one claim, because more than one insurance policy covers the incident. The system then automatically fills out all the claim forms the insured member is entitled to file and files them on behave of the insured member after obtaining his authorization and/or electronic signature.

FIG. 5 is an exemplary screen capture 500 of a window of a centralized insurance claim processing and plan management website that shows how filled out claim forms are presented to an insured member, in accordance with various embodiments. In screen capture 500, the insured member receives both a filled out group personal accident plan claim form 510 and a filled out hospitalization plan claim form 520, for example.

The system provides an interface to allow, for example, a system administrator, to see and comment on all of the claims filed by the insured member. For example, the system provides a chart or table that lists all of the claims filed by the insured member in the past. The chart or table includes, for example, the insured member's name, company, claim type, date of filing. When a particular claim is selected, the system shows all the details, including the responses provided by the insured member. The system administrator can optionally docket a reminder to remind the insured member to send in required paperwork, such as signed forms or evidence needed for a claim.

### System for Automatically Filling Out Claim Forms

FIG. 6 is a schematic diagram of a system 600 for automatically filling out claim forms based on an insured member's responses to questions, in accordance with various embodiments. System 600 includes one or more client devices 610, one or more databases 620, and one or more computer servers 630. One or more client devices 610 can include, but are not limited to, smartphones, wearable computers, tablet computers, personal digital assistants, music players, game players, or personal computers.

One or more databases 620 store a plurality of insured members and a plurality of insurance policies. One or more databases 620 link each member of the plurality of insured members to one or more policies of the plurality of insurance policies. One or more databases 620 also link each policy of the plurality of insurance policies to claim rules for each policy. One or more databases 620 can include any type of electronic or magnetic storage.

One or more servers 630 are in communication with one or more devices 610 and one or more databases 620. One or more servers 630 can be any type of computer system, such as the computer system of FIG. 1. One or more computer servers 630 can include one or more web servers, for example. One or more servers 630 receive a request from a device 610 of an insured member to process a claim for an incident. One or more servers 630 retrieve one or more specific insurance policies for the insured member from one or more databases 620. One or more servers 630 also retrieve claim rules for each policy of the one or more specific insurance policies from one or more databases 620. As a result, one or more claim rules are produced for the insured member.

One or more servers 630 generate one or more claim questions specifically for the insured member based on the one or more claim rules. One or more servers 630 send the one or more claim questions to device 610 of the insured member regarding an incident. One or more servers 630 receive one or more responses from device 610 of the insured member in response to the one or more claim questions. One or more servers 630 select one or more claim forms of one or more policies of the one or more specific insurance policies based on the one or more responses and the one or more claim rules. One or more servers 630 fill out the one or more claim forms based on the one or more responses.

In various embodiments, one or more servers 630 further electronically file the one or more claim forms with one or more insurance carriers.

In various embodiments, the one or more claim questions sent to device 610 of the insured member include questions that require a yes or no response.

In various embodiments, the incident can include, but is not limited to, an illness, an accident, an elective procedure, or a maintenance issue with an insured item.

In various embodiments, one or more databases 620 further include personal information for the insured member. One or more servers 630 can retrieve this information from one or more databases 620 and can use this information in addition to the responses received from questions to fill out the one or more claim forms.

In various embodiments, the claim rules can include, but are not limited to, questions to be asked for each policy or rules about how information gather for one policy can be used for another policy. For example, an insured member may be covered by more than one hospitalization plan. The claim rules for each hospitalization plan may then contain a rule requiring one or more servers 630 to determine which hospitalization plan is the primary plan for the insured member and which hospitalization plan or plans are secondary. The may be determined from information about the plans in one or more databases 620 or from questions asked of the insured member.

In various embodiments, one or more servers 630 generate the minimum number of questions needed to fill out multiple claims forms. For example, one or more servers 630 compare the claim rules of at least two insurance policies. One or more servers 630 then generate at least one claim question that results in information for claim forms of both of the at least two insurance policies.

### Method for Automatically Filling Out Claim Forms

FIG. 7 is a flowchart showing a method 700 for automatically filling out claim forms based on an insured member's responses to questions, in accordance with various embodiments.

In step 710 of method 700, a request is received from a device of an insured member to process a claim for an incident using a server computer.

In step 720, one or more specific insurance policies for the insured member are retrieved from a database and claim rules for each policy of the one or more specific insurance policies are retrieved from the database using the server computer, producing one or more claim rules for the insured member. The database includes a plurality of insured members and a plurality of insurance policies. The database links each member of the plurality of insured members to one or more policies of the plurality of insurance policies and links each policy of the plurality of insurance policies to claim rules for the each policy.

In step 730, one or more claim questions are generated specifically for the insured member based on the one or more claim rules using the server computer.

In step 740, the one or more claim questions are sent to the device of the insured member regarding an incident using the server computer.

In step 750, one or more responses are received from the device of the insured member in response to the one or more claim questions using the server computer.

In step 760, one or more claim forms of one or more policies of the one or more specific insurance policies are selected based on the one or more responses and the one or more claim rules using the server computer.

In step 770, the one or more claim forms are filled out based on the one or more responses using the server computer.

### Computer Program Product for Automatically Filling Out Claim Forms

In various embodiments, computer program products include a tangible computer-readable storage medium whose contents include a program with instructions being executed on a processor so as to perform a method for automatically filling out claim forms based on an insured member's responses to questions. This method is performed by a system that includes one or more distinct software modules

FIG. 8 is a schematic diagram of a system 800 that includes one or more distinct software modules that performs a method for automatically filling out claim forms based on an insured member's responses to questions, in accordance with various embodiments. System 800 includes storage module 810 and analysis module 820.

Analysis module 820 receives a request from a device of an insured member to process a claim for an incident. Storage module 810 retrieves one or more specific insurance policies for the insured member from a database and claim rules for each policy of the one or more specific insurance policies from the database, producing one or more claim rules for the insured member. The database includes a plurality of insured members and a plurality of insurance policies. The database links each member of the plurality of insured members to one or more policies of the plurality of insurance policies and links each policy of the plurality of insurance policies to claim rules for the each policy.

Analysis module 820 generates one or more claim questions specifically for the insured member based on the one or more claim rules. Analysis module 820 sends the one or more claim questions to the device of the insured member regarding an incident. Analysis module 820 receives one or more responses from the device of the insured member in response to the one or more claim questions. Analysis module 820 selects one or more claim forms of one or more policies of the one or more specific insurance policies based on the one or more responses and the one or more claim rules. Analysis module 820 fills out the one or more claim forms based on the one or more responses.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for automatically filling out claim forms based on an insured member's responses to questions, comprising:
a database that includes a plurality of insured members and a plurality of insurance policies, wherein the database links each member of the plurality of insured members to one or more policies of the plurality of insurance policies and links each policy of the plurality of insurance policies to claim rules for the each policy;
a server computer that
receives a request from a device of an insured member to process a claim for an incident,
retrieves one or more specific insurance policies for the insured member from the database and claim rules for each policy of the one or more specific insurance policies from the database, producing one or more claim rules for the insured member,
generates one or more claim questions specifically for the insured member based on the one or more claim rules,
sends the one or more claim questions to the device of the insured member regarding an incident,
receives one or more responses from the device of the insured member in response to the one or more claim questions,
selects one or more claim forms of one or more policies of the one or more specific insurance policies based on the one or more responses and the one or more claim rules, and
fills out the one or more claim forms based on the one or more responses.

2. The system of claim 1, wherein the server computer further electronically files the one or more claim forms with one or more insurance carriers.

3. The system of claim 1, wherein the one or more claim questions comprise questions that require a yes or no response.

4. The system of claim 1, wherein the incident comprises an illness or an accident.

5. The system of claim 1, wherein the database further comprises personal information for the insured member and the server computer fills out the one or more claim forms based on the personal information in addition to the one or more responses.

6. The system of claim 1, wherein the claim rules for the each policy comprise questions to ask an insured member.

7. The system of claim 1, wherein the server computer generates one or more claim questions specifically for the insured member based on the one or more claim rules by
comparing the claim rules of at least two insurance policies and generating at least one claim question that results in information for claim forms of both of the at least two insurance policies.

8. A method for automatically filling out claim forms based on an insured member's responses to questions, comprising:
receiving a request from a device of an insured member to process a claim for an incident using a server computer;
retrieving one or more specific insurance policies for the insured member from a database and claim rules for each policy of the one or more specific insurance policies from the database using the server computer, producing one or more claim rules for the insured member, wherein the database includes a plurality of insured members and a plurality of insurance policies, and wherein the database links each member of the plurality of insured members to one or more policies of the plurality of insurance policies and links each policy of the plurality of insurance policies to claim rules for the each policy;
generating one or more claim questions specifically for the insured member based on the one or more claim rules using the server computer,
sending the one or more claim questions to the device of the insured member regarding an incident using the server computer,
receiving one or more responses from the device of the insured member in response to the one or more claim questions using the server computer,
selecting one or more claim forms of one or more policies of the one or more specific insurance policies based on the one or more responses and the one or more claim rules using the server computer, and
filling out the one or more claim forms based on the one or more responses using the server computer.

9. The method of claim 8, further comprising electronically filing the one or more claim forms with one or more insurance carriers.

10. The method of claim 8, wherein the one or more claim questions comprise questions that require a yes or no response.

11. The method of claim 8, wherein the incident comprises an illness or an accident.

12. The method of claim 8, wherein the database further comprises personal information for the insured member and filling out the one or more claim forms comprises using the personal information in addition to the one or more responses.

13. The method of claim 8, wherein the claim rules for the each policy comprise questions to ask an insured member.

14. The method of claim 8, wherein generating one or more claim questions specifically for the insured member based on the one or more claim rules comprises
comparing the claim rules of at least two insurance policies and generating at least one claim question that results in information for claim forms of both of the at least two insurance policies.

15. A computer program product, comprising a non-transient, tangible computer-readable storage medium whose contents include a program with instructions being executed on a processor so as to perform a method for automatically filling out claim forms based on an insured member's responses to questions, the method comprising:
providing a system, wherein the system comprises distinct software modules, and wherein the distinct software modules comprise a storage module and an analysis module;
receiving a request from a device of an insured member to process a claim for an incident using the analysis module;
retrieving one or more specific insurance policies for the insured member from a database and claim rules for each policy of the one or more specific insurance policies from the database using the storage module, producing one or more claim rules for the insured member, wherein the database includes a plurality of insured members and a plurality of insurance policies, and wherein the database links each member of the plurality of insured members to one or more policies of the plurality of insurance policies and links each policy of the plurality of insurance policies to claim rules for the each policy;
generating one or more claim questions specifically for the insured member based on the one or more claim rules using the analysis module,
sending the one or more claim questions to the device of the insured member regarding an incident using the analysis module,
receiving one or more responses from the device of the insured member in response to the one or more claim questions using the analysis module,
selecting one or more claim forms of one or more policies of the one or more specific insurance policies based on the one or more responses and the one or more claim rules using the analysis module, and
filling out the one or more claim forms based on the one or more responses using the analysis module.

16. The computer program product of claim 15, further comprising electronically filing the one or more claim forms with one or more insurance carriers.

17. The computer program product of claim 15, wherein the one or more claim questions comprise questions that require a yes or no response.

18. The computer program product of claim 15, wherein the incident comprises an illness or an accident.

19. The computer program product of claim 15, wherein the database further comprises personal information for the insured member and filling out the one or more claim forms comprises using the personal information in addition to the one or more responses.

20. The computer program product of claim 15, wherein the claim rules for the each policy comprise questions to ask an insured member.
